(19) United States
(12) Patent Application Publication
(10) Pub. No.: US 2023/0205660 A1
(43) Pub. Date: Jun. 29, 2023

(54) Method And System For Computing Aggregable And Aligned Fingerprints Of Sets For Fast Cardinality, Overlap And Similarity Computation

(71) Applicant: Dynatrace LLC, Waltham, MA (US)

(72) Inventor: Otmar ERTL, Linz (AT)

(73) Assignee: Dynatrace LLC, Waltham, MA (US)

(21) Appl. No.: 18/146,529

(22) Filed: Dec. 27, 2022

Related U.S. Application Data
(60) Provisional application No. 63/294,230, filed on Dec. 28, 2021.

(51) Int. Cl. G06F 11/34; H04L 67/10

(52) U.S. Cl. CPC G06F 11/3409; H04L 67/10

(57) ABSTRACT

A probabilistic set sketching data structure for the estimation of properties of individual sets, like cardinality, as well as joint parameters describing relations between different sets, like similarity scores or intersection cardinalities. The memory size of the proposed sketch is widely independent of the size of the observed sets and may be chosen primarily based on the desired estimation error. A tuning parameter controls the amount of information stored in the sketch regarding the content of the monitored set and may be used to trade joint parameter estimation accuracy for sketch size. Improved estimation algorithms are proposed for both cardinality and joint quantities. Especially the proposed joint quantity estimation has considerable advantages, as it reduces the problem of estimating three dependent parameters, like the cardinalities of intersections and the two complements to the estimation of only one parameter, like the Jaccard coefficient.

### CROSS-REFERENCE TO RELATED APPLICATIONS

This application claims the benefit of U.S. Provisional Application No. 63/294,230, filed on Dec. 28, 2021. The entire disclosure of the above application is incorporated herein by reference.

### FIELD

The disclosed invention generally relates to the field of creating and evaluating probabilistic data structures that describe individual large sets and relationships between multiple large sets and more specifically to a sketching data structure that can be configured according to requirements for space efficiency, cardinality, and joint parameter estimation.

### BACKGROUND

The amount of data generated by modern society is measured in zetta bytes and applications need to cope with those vast amounts of data to gain valuable insights. Most of the times, exact analysis results are not required, as long as estimates with known, controllable error behavior are available.

Set-related analysis tasks, like calculating/estimating the cardinality of sets or overlap/similarity metrics for two or more sets are frequently required, fundamental analysis tasks.

Sketch/fingerprint data structures represent specific characteristics of input set with a defined error probability, require—in relation to the analyzed sets—small storage space and can be analyzed with relatively low computational effort.

Different types of sketches exist for different analysis tasks, like estimation of set cardinalities or estimation of joint parameters of multiple sets, like Jaccard or cosine similarity coefficients, intersection cardinality or inclusion coefficients.

Up to now, there exists no sketch data structure that is natively suitable for the estimation of both set cardinalities and joint parameters.

Application of such sketch data structures is basically subdivided in the task of sketch data structure creation, which typically requires a more or less (computational) expensive analysis of the input set, followed by the analysis of the created sketch, which may require calculations of various complexity causing various computational effort. In addition, analysis results are affected by estimation errors that depend on the type of sketch and the selected analysis.

Modern applications typically employ multiple, parallel processing nodes to cope with ever increasing amounts of data that needs to be process. Therefore, it is important for a sketch data structure that recording is also suitable for such parallel environments. To achieve this, recording of sketch data should be idempotent (adding the same source data element to the sketch a second time does not change the sketch), commutative (first adding element a and then element b should give the same result as first adding b and then a) and mergeable (a combination of sketch a′ representing set a with sketch b′ representing set b should be equal to a sketch representing the set union of a and b).

In addition, to support high processing volumes, adding elements to a sketch data structure should be fast and require low computational effort.

Existing sketching approaches lack in one or more of those requirements or require overly complex analysis procedures that, in some cases partly depend on heuristics.

In addition, for all known sketch data structures, the only possible measure to improve the estimation error guarantees is to increase the size of the sketch. It is not possible to e.g., trade in a reduced maximum supported cardinality for a higher estimation accuracy for smaller cardinalities.

Consequently, there is demand in the field for an improved sketching procedure that provides fast, idempotent, and commutative recording, which supports merging of recorded sketches, and which provides fast and accurate estimation mechanisms that do not depend on heuristics or “magic numbers”. The desired sketching approach should also be configurable to support only restrict recording conditions, like the restricting the range of supported input set cardinalities to an expected value range. In return, the estimation accuracy for sets in the specified cardinality range should be improved.

This section provides background information related to the present disclosure which is not necessarily prior art.

### SUMMARY

This section provides a general summary of the disclosure, and is not a comprehensive disclosure of its full scope or all of its features.

This disclosure describes a sketching data structure which is capable to describe and estimate both individual set parameters, like a set cardinality and parameters describing the relations between different sets, like intersection cardinality or overlap and similarity measures.

The proposed sketch data structure (SetSketch) consists of a list of registers with a specific value range. Two parameters may be used to adapt the recording behavior of sketch updates according to expected cardinality ranges and desired estimation accuracy. A first parameter (a) may be used to adapt the recording behavior according to expected minimal cardinalities and a second parameter (b) may be used to adapt the recording according to a desired accuracy for the estimation of joint parameters, where an increase of the estimation accuracy leads to a decrease of the maximal supported cardinality for a given register number and register value range.

Recording of set elements into SetSketch records may be performed in a distributed way, where parts of analyzed sets may be recorded into different sketch records which may afterwards be combined to create a sketch that represents the complete set.

The sketch data structure may be defined in a way that register values are only increased with every update. In addition, candidate values for register updates for a given input element may be calculated in decreasing order and the overall minimum register value of the sketch may be observed. Processing of the given input element may be terminated when the update value candidate becomes smaller than the overall minimum register value. Exemplary embodiments may count the number of performed register updates and if this number of register value updates exceeds a threshold (e.g., the number of registers), scan the register values to determine the current minimum register value.

To create random, incrementing register update value candidates, some embodiments may create random numbers by incrementing a given random number by another random number. Alternative embodiments may create a set of incrementing value ranges for random numbers by defining a set of ascending, adjacent value ranges and then draw random numbers in ascending order from those value ranges.

Calculating register value updates includes calculating a logarithm from a hash value and then truncating the result of this logarithm to an integer number. As only an infinite number of integer numbers lead to an update of the sketch data structure (values from 0 to the maximum value a register can store), some variant embodiments may in advance create lookup tables which map value ranges of hash values to corresponding integer numbers to avoid the computationally expensive logarithm calculations.

Some embodiments may, to estimate set cardinalities, calculate the value of a function for each register value and calculate the sum of the register values as part of the cardinality estimation. Variant embodiments may instead in advance create a lookup table which maps each possible register value to a corresponding function value and then uses this lookup table to calculate the sum of function values instead of repeatedly calculating the function values for received register values.

Other embodiments may, to calculate estimates for joint parameters for two sets described by two SetSketch records, determine for a given desired joint parameter a representation that depends on the cardinalities of the two sets and a joint parameter like the Jaccard coefficient. Then those embodiments may calculate an estimate for cardinality of both sets (if they are not known) using the received SetSketch records and determine the number of registers D− having a smaller value in the first record, the number D₊ of registers having a smaller value in the second record and the number Do of register values that have the same value in both records. A max-likelihood function may be specified which describes the likelihood of values of the selected joint parameter (Jaccard coefficient) under the given observations defined by the set cardinalities, and the differential register value statistics D₋, D₊ and D₀. The max-likelihood function may be used to identify the most likely value of the chosen joint parameter under the given observations, and the estimate for the desired joint parameter may be calculated using the estimate for the chosen joint parameter and the cardinalities.

Alternative embodiments may use sketch records that were recorded using a different sketching method, like the MinHash sketching method, determine the number of register values that are smaller in the first records, the number of register values that are smaller in the second record and the number of register values that are equal in both registers and use this register-difference data together with cardinality data for the described sets to calculate an estimate for a joint parameter for the described sets, like the Jaccard coefficient.

Still other embodiments may use SetSketch records to create indices that use the locality sensitivity of SetSketch. To create such an index, the registers of the sketch are segmented, and a segment bucket containing a map from register segment values to lists of sketches having the register segment value is created. For an incoming sketch that should be inserted into the index, first the register segment values are calculated for each segment, and then the sketch is added to each segment bucket, into the signature list that is mapped to the corresponding register segment value of segment of the incoming sketch.

For an incoming sketch for which corresponding sketches should be searched in the index, the incoming sketch is also separated into the segments, and the values of the segments are calculated. Afterwards, signatures for which respective segment values match are selected as match candidates from each segment bucket. The match candidates may afterwards be filtered to get a final result.

In some variant embodiments, known information about to be analyzed sets, like the cardinality of the set cardinality, this knowledge may be used to adapt the value of variables that control the recording process to improve the performance of the recording process.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 shows a block diagram of a distributed sketch recording system consisting of multiple, distributed recording entities and one aggregating entity which receives and merges partial sketches and stores the resulting sketches, and then performs desired estimation calculates on stored sketches.

FIG. 2 shows exemplary data structures that may be used to store SetSketch records during and after recording and that may be used to store recording configuration data.

FIG. 3 conceptually describes the process of configuring the recording parameter for a SetSketch recording process.

FIG. 4 provides a general overview of data element recording, including the selection/creation of SetSketch records for sets to which received data elements belong.

FIG. 5 provides the flow chart of a process to record data elements to a SetSketch record, including optimizations, like ordered generation of random update numbers combined with a check for random number values that cannot change the state of the sketch record to implement an early exit for data element recording.

FIG. 6 conceptually shows two alternative methods to create random values in ordered fashion.

FIG. 7 shows the flow chart of a process that merges two or more SetSketch records into a result record.

FIG. 8 provides the flow chart of a process that estimates the cardinality of a set from a SetSketch record.

FIG. 9 shows the process of calculating estimates for joint parameters, like Jaccard coefficient, intersection cardinality or relative overlap for two sets represented by two received SetSketch records.

FIG. 10 describes a process that applies the joint parameter estimation method for SetSketch on sketch data records of another, similar type, like MinHash sketch records.

FIG. 11 conceptually shows the usage of SetSketch record for the creation and usage of index structures that are based on the locality sensitivity of SetSketch records.

FIG. 12 shows a flow chart of an optimized SetSketch recording process for situations where the cardinality of a to be recorded set is known in advance and where the set elements can be processed multiple time.

Corresponding reference numerals indicate corresponding parts throughout the several views of the drawings.

### DETAILED DESCRIPTION

Example embodiments will now be described more fully with reference to the accompanying drawings.

The described exemplary embodiments are directed to the creation of sketching data structures that contain both information about the cardinality of sets and information about the similarity or overlap of different sets. Other than sketching data structures that are known in the art, where the only configuration parameter is the amount of memory allotted to individual sketch records (i.e., number of registers of a sketch and value range of individual registers), the proposed sketching approach provides additional configuration parameters to adapt for expected minimum and maximum cardinalities and to trade supported maximum cardinality for increased estimation accuracy for joint parameters (i.e., Jaccard coefficient, relative overlap, cardinality of intersection).

The proposed sketching approach is capable for high-volume, distributed systems as it provides an easy, fast, and robust way to merge already recorded sketches representing portions of sets into sketch records representing the unions of those set portions.

To also record more detailed information about observed sets that are required for the estimation of joint parameters, the recording process needs to calculate random register update candidate values, which are used to update register values if the current register value has a specific relation (greater or smaller) to the candidate update value, which implies that register values only increase or decrease in a monotonic fashion. Random update values may be generated also in an inversely monotonic fashion (i.e., if register values decrease monotonically, the update values may be created in a monotonically increasing fashion). If the value of the “most lagging” register (i.e., register with smallest value for monotonically increasing register values or vice versa) passes the value of the current update value candidate, processing of the currently analyzed set element can be terminated because no subsequent update value candidate can change any register value. To track the most lagging register value, the recording process may monitor the number of register value updates and perform a scan for the current most lagging register value when the number of updates exceeds a certain threshold (i.e., the number of register updates exceeds the number of registers in the sketch).

Various approaches may be used to create random register update values in an ordered fashion, including calculating update values as sum of a new random value and all previously calculated update values or segregating the value range for update values into adjacent, ascending intervals and drawing random values in ascending order from those intervals.

Cardinality estimation is based on the sum of recorded register values and estimation of joint parameters from two sketch records is based on the number of equal register values, the number of registers that are smaller in the first record and the number of register values that are smaller in the second record.

The proposed evaluation method to calculate estimates for joint parameters may also be applied to sketches that are recorded using other sketching approaches for joint parameters, like MinHash sketches.

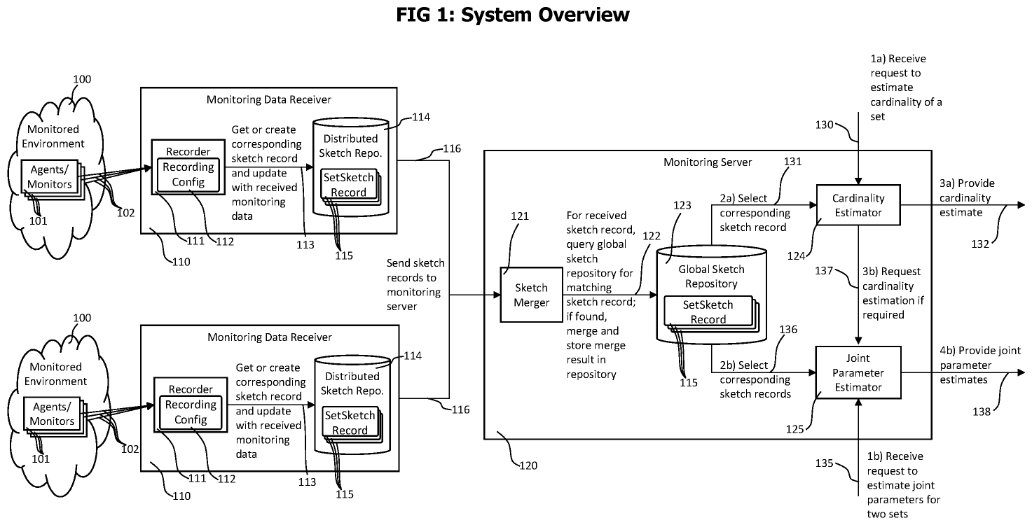

Coming now to FIG. 1, which provides a block diagram of a distributed monitoring system for large-size sets, consisting in a set of distributed monitoring data receives 110, which receive data elements from to be monitored sets and recording received data elements in SetSketch records 115 and a central monitoring server 120 which receives 116 and merges partial SetSketch records from different monitoring data receivers and stores the merged SetSketch records for later estimation requests for cardinalities of individual sets or for estimations for parameters describing the relations between two sets, like cardinality of intersection, relative overlap or similarity metric like the Jaccard index.

Agents, monitors, or other types of monitoring data sources 101 may be deployed to monitored environments 100 and provide streams of monitoring data elements, which are received by recorder components 111 of distributed monitoring data receiver components 110.

The recorder components may use recording config 112 to analyze received data elements to determine the monitored set to which the received data elements belong. Received data elements may be of various types and may contain various information. Data elements may describe users that interact with a monitored application and contain data to distinguish between different users, or they may contain data describing the activities those users performed. As examples, recording configuration may specify that data describing sets of individual users, or data describing the set of different activities performed by those users should be recorded. Various variants and types of data elements and various types of groupings of those data elements into sets are possible and recording configuration variants may define those various groupings. In addition to data defining the to be recorded sets, recording configuration also contains data describing the structure of the sketching data records and data that is used to configure the recording process. The recording config 112 may e.g., specify the number of registers contained in a sketch data structure or the capacity of individual registers in form of the maximum value a register can store. In addition, the recording config may contain data to adapt the recording process according to the expected minimum and maximum set cardinalities and according to a desired quality for joint parameter estimations.

On receipt of a data element, the recorder component 111 may analyze the data element according to its recording config 112 to determine the set to which the data element should be recorded. It is noteworthy that one data element may be used as input for multiple sets.

The recorder component 111 may then query the local distributed sketch repository 114 of the monitoring data receiver 110 for a SetSketch record 115 describing the set to which the received data element belongs. If no matching SetSketch record 115 is found, a new one may be created according to the settings of the recording configuration and stored in the local distributed sketch repository 114. The received data element may then be recorded to the selected SetSketch record according to the recording parameters defined in the recording configuration 112.

Monitoring data receivers 110 may cyclically send 116 SetSketch records 115 via a connecting computing network (not shown) to a monitoring server. The monitoring data receivers may delete sent SetSketch records from their local distributed SetSketch repository 114.

A sketch merger component 121 of the monitoring server 120 may receive the SetSketch records from the distributed recorders 110 and query a global sketch repository 123 for SetSketch record describing the same set as the received SetSketch records. In case such a matching SetSketch record is found in the global sketch repository, the received sketch records may be merged with the matching sketch record that was found in the global repository.

Distributed recording of data elements into separate sketch records by multiple monitoring data receivers 115 and later merging of those separate records increases the scalability of the recording capacity of the monitoring system. With this configuration it would be sufficient to add additional monitoring data receives to adapt the monitoring system for increased monitoring load, as the merging of already recorded sketch records is a relatively efficient operation.

Cardinality estimator 124 and joint parameter estimator 125 components of the monitoring server may access the SetSketch records stored in the global sketch repository to fulfill various set cardinality and set relation estimation requests.

The cardinality estimator 124 may receive a request to estimate the cardinality of a specific set. Data to identify the sketch record describing the set for which a cardinality estimate is requested may be included in the received request. The cardinality estimator may query the sketch representing the set for which a cardinality estimation is requested from the global sketch repository 115, calculate the cardinality estimation and provide it 132 to the requester.

The joint parameter estimator 125 may receive a request 135 to estimate a specific joint parameter for two sets, where the request may contain data to identify the sketch parameters representing both sets and it may also specify the joint parameter for which an estimation is required. The joint parameter estimator 125 may fetch 136 the required SetSketch records 115 from the global sketch repository 123. For the estimation of some joint parameters also, cardinality data may be required. If cardinality data is not already available, the joint parameter estimator may request 137 required cardinality estimations from the cardinality estimator 124. The joint parameter estimator 125 may then calculate an estimation value for the specified joint parameter using the fetched sketch records and the available cardinality data and provide 138 the result of the estimation to the requester.

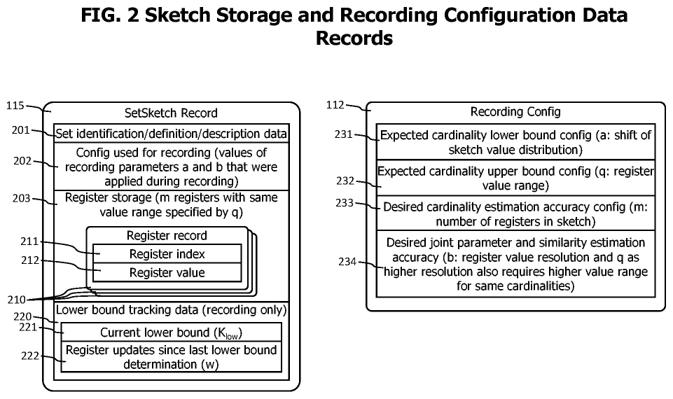

Coming now to FIG. 2, which conceptually describes data structures to hold SetSketch recording data 115 and to store SetSketch recording configuration data 112.

A SetSketch record 115 may contain but is not limited to set identification, definition and description data 201, which may be used to map a given SetSketch to the set it describes, recording configuration data 202 which may contain recording parameter settings that controls the recording process and that cannot be extracted from the format of the SetSketch record, a register storage 203 containing a set of register records 210 which hold the data that was extracted from individual elements of the described set and lower bound tracking data 220 containing data that may be used to improve the efficiency of the recording process.

Recoding configuration data 202 may contain data for recording parameters that control the information that is stored for set similarity estimations. Basically, changing the recording behavior to preserve and store more set similarity information in a SetSketch data of a given size also changes the supported cardinality range. An increase of stored similarity information leads to a decrease of the supported cardinality range. As the value of configuration parameters that controlled this recording behavior cannot be extracted from the structure of the SetSketch record (e.g., number or capacity of registers in the register storage 203 of the sketch record), and as they may be required for the interpretation of the data recorded to the SetSketch record, they may be stored in the SetSketch record.

Register records 210 may contain but are not limited to a register index 211 identifying a specific register within its enclosing sketch record and a register value 212 storing the current value of the specific registers. Various implementations may be used to represent such sequences of register records, including array data types provided by most programming languages. In the following, the number of registers in the register storage 203 is referred to as parameter m and the value range of those register is referred to as q.

Lower bound tracking data 220 may be used and maintained during the recording process to identify and skip recording operations on received data elements that cannot change the value of any register.

To record a data element into a SetSketch record, update value candidates may be derived from the data element in ascending order, and a selected register value may only be updated to the candidate value of it is currently less than the candidate value. Therefore, the process can be terminated early if the lowest register value is known, and the candidate value is less than this lowest register value, as the candidate value cannot update the value of any register.

Lower bound tracking data 220 may contain but is not limited to a current lower bound value 221 storing the currently known lowest register value and a register update count 222 which records the number of register updates since the last update of the lower bound. The register update count may be used to trigger an update of the lower bound value after a specific number of register updates has occurred since the last update of the lower bound value.

Recording configuration records 112, which may be used by recorder components 111 to create new SetSketch records 115 and to configure the recording behavior may contain but are not limited to parameters 231 to adapt the recording behavior to an expected lower bound of cardinalities of to be records set, parameters 232 to adapt a create SetSketch record to an expected cardinality upper bound (register value range q), parameters 233 to adapt a created SetSketch record to a desired cardinality estimation accuracy (number of registers of created SetSketch records m), and parameters 234 to adapt the recording behavior to a desired accuracy for joint parameter estimations (register value resolution b to adapt the joint parameter estimation accuracy, and also register value range parameter q, if a changed joint parameter accuracy is desired in combination with an unchanged range of supported cardinalities, as a change of register resolution b also changes the amount of information that is stored in registers for individual set elements. If the register resolution is increased, the maximum supported cardinality is decreased. To compensate this decrease of supported cardinality, the register value range may be increased by increasing parameter q).

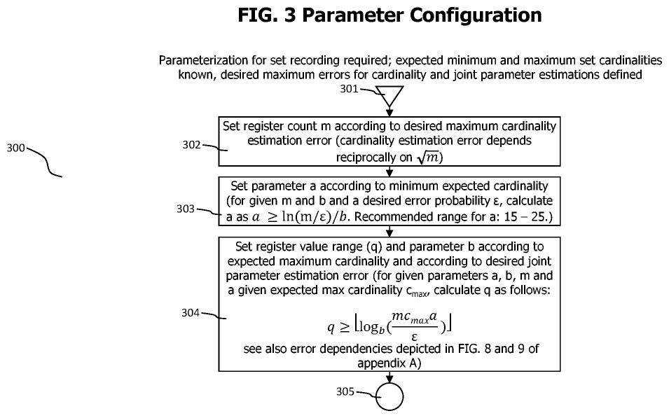

Coming now to FIG. 3, which conceptually describes the process of configuration of the SetSketch recording behavior according to expected cardinality ranges of to be recorded sets and according to desired accuracies of cardinality and joint parameter estimations.

The process 300 starts with step 301 when monitoring of set parameters for a new type of sets should be started and an expected minimum and maximum cardinality of the to be monitored sets is known and an acceptable maximum estimation error for set cardinality and set joint parameters for the to be monitored sets are defined.

In following step 302 the register count (m) for the SetSketch records is set depending on the desired cardinality estimation accuracy. For a specified maximum acceptable cardinality error ε, the register count may be chosen in a way that the reciprocal of the square root of m is smaller than ε.

Afterwards, step 303 may determine and set parameter a to a value that is higher than the natural logarithm of the quotient of m and ε, divided by the register value resolution parameter b. Parameter a controls the probability that negative register update values occur. As negative values cannot be recorded in the SetSketch registers, the probability of negative register values should be minimized. Setting parameter a to a value from 15-25 reduces the probability of negative register value updates and their caused estimation error to a negligible value for sets with cardinality 1. If a minimum expected cardinality is known, parameter a may be set to a lower value to save register capacity.

Step 304 may afterwards be used to set the register value range q and the register value resolution parameter b according to the expected maximum cardinality of observed sets and the maximum acceptable estimation error for joint parameter estimations.

The parameters q and b may be set according to the formula depicted in step 304, where q depends on the logarithm with base b form the product of m, the maximum supported cardinality (cₘₐₓ) and parameter a, divided by the maximum tolerable error for joint parameter estimation ε. Parameter b is inversely proportional to the register value resolution. The smaller b is, the more register space is required to hold data of sets with a given maximum supported cardinality and a give maximum estimation error. Therefore, it may be required to increase the register capacity parameter q if higher accuracy is desired for joint parameter estimations. The process then ends with step 305.

In other words, parameter b may be considered to control the amount of similarity information that is “encoded” into the stored register values. Increasing the amount of stored similarity information for a given register capacity q decreases the number of distinct data elements that can be recorded to a SetSketch record. To compensate this decreased cardinality capacity, the register value capacity q may be increased. Values for parameter b should be set greater than 1, but arbitrarily near to 1. Values smaller than 2 generate joint parameter accuracies that are higher than those of sketching approaches that are known in the art.

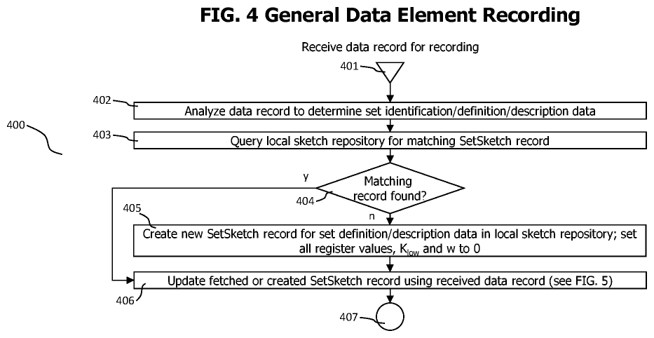

The process of receiving data elements, identifying corresponding SetSketch records and to recording the received data elements to their respective SetSketch records is shown in FIG. 4.

The process 400 starts with step 401, when a new data element is received by a recorder component 111. Following step 402 may then analyze the received data element determine the set identification, definition, and description data for the set to which the received data element belongs. As mentioned earlier, a data element may be part of multiple sets. As an example, a received data element may contain data describing a user login event to a specific application, and the event may contain an indication if the logging in user is a returning or a new user. Step 402 may analyze this data and the data element to sets describing new or returning users based on the new/returning indicator of the received data element. It may also assign the data element to a set describing all logins, or it may assign it to a set describing the logins for the specified application.

Following step 403 may then search the local sketch repository 114 for a SetSketch record 115 with matching set identification/definition/description data 201 and subsequent decision step 404 may continue with step 405 if no matching SetSketch record is found. Step 405 creates a new SetSketch record for the desired set identification/definition/description with number of registers and register capacity as defined in the recording configuration 114, sets recording configuration 202 (parameters a and b) according to corresponding recording configuration settings (expected cardinality lower bound configuration 231 and desired joint parameter estimation accuracy configuration 234), sets the values 212 of all register records 210, the current lower bound (K_{low}) 221, and the register update counter w 222 to 0. Afterwards, the process continues with step 406.

If a matching SetSketch record was found in step 403, decision step 404 directly continues with step 406.

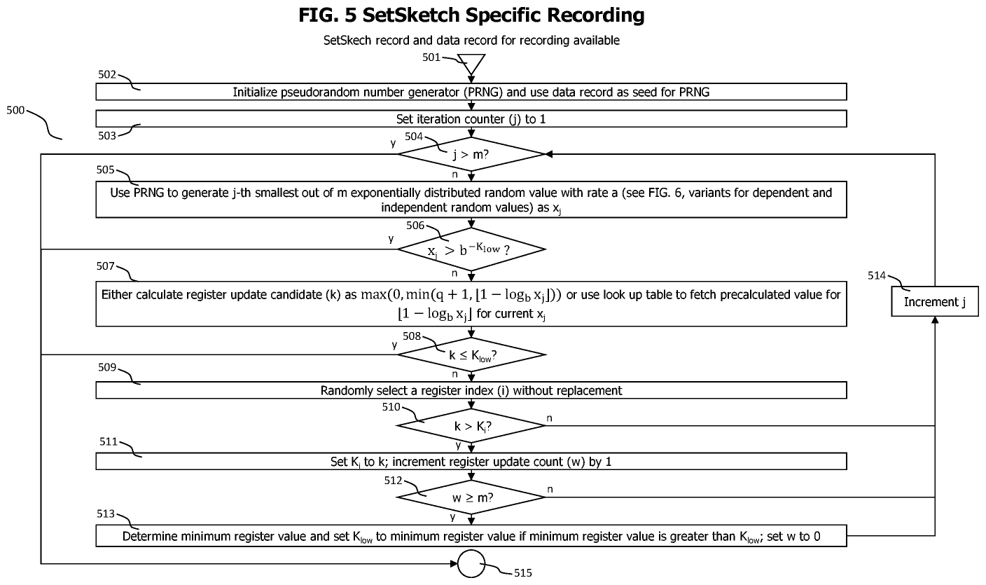

Step 406 then records the received data element to the fetched or created SetSketch record 115. A detailed description of this process can be found in FIG. 5. The process then ends with step 407.

The processing of a received data element to update a SetSketch record that describes a set to which the data element belongs is shown in FIG. 5. The process 500 starts with step 501 when a new data record and the SetSketch record to which the data record should be recorded are available.

Following step 502 creates a pseud random number generator (PRNG) using the received data record as seed for the created PRNG. PRGNs create sequences of randomly distributed numbers, where the generated number sequences are determined by the seed value. Two PRNGs that were initialized with the same seed value create exactly the same number sequences.

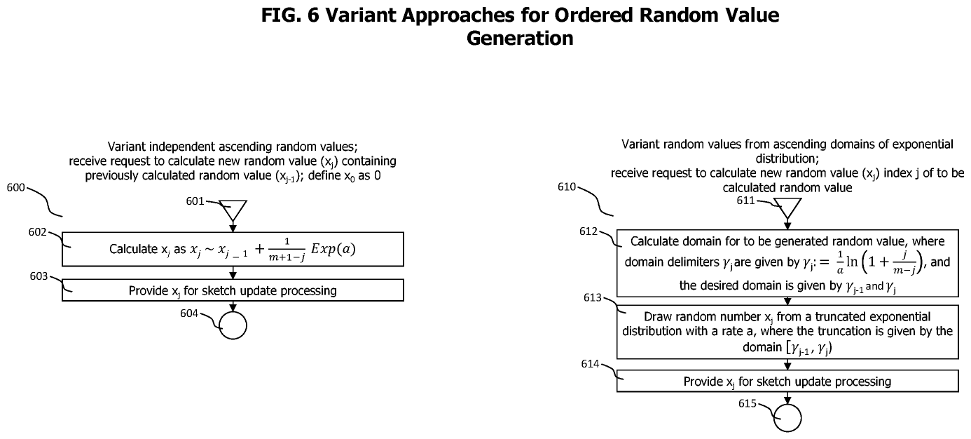

Following step 503 creates an iteration counter j and sets it to 1. Subsequent decision step 504 determines whether the iteration counter is greater than the register count m of the received SetSketch record 115. If j is greater than the m, the processing of the current data record is finished, and the process ends with step 515. Otherwise, decision step 504 continues with 505 which uses the PRNG to create an ascending, exponentially distributed random value xⱼ, where rate of the exponential distribution from which the random values are drawn is set to the configuration parameter a. Step 505 may draw the smallest random number for the first iteration (x₁), the second smallest (x₂) for the second iteration and so on, until the m-th iteration is reached and the largest random number is drawn. Various approaches may be used to create random values matching above requirements, two of those are described in more detail in FIG. 6.

Afterwards, decision step 506 may compare the created random number with the result of the configuration parameter b taken to the power of −K_{low} and terminates the process with step 515 if xⱼ is greater, as with this relation of xⱼ and K_{low}, neither xⱼ, nor any subsequently created ascending random number may change any register value.

Otherwise, step 507 is executed which determines a register update candidate value k, either by the formula provided in 507, which first evaluates the logarithm of base b for xⱼ, truncates the result of the logarithm result to an integer number and then truncates the integer number to the register value range (0 to q+1). Alternatively, a lookup table may be used, which defines a mapping for each possible register value (0 to q+1) which maps value ranges for created random values to corresponding register values. As the result of the logarithm evaluation being truncated to the next integer number to get the register update candidate value, there is a range of logarithm results, and therefore also a range of random values for each possible register value that lead to the same update candidate value. The lookup table may specify a mapping for each of this value ranges for the random number to the corresponding register value. If a new random value xⱼ is received, it may first be determined into which range of the lookup table this value falls (e.g., by using binary search algorithms), and then the result value that the lookup table maps to the determined range may be used as update value candidate k. The value ranges of the lookup table may be determined by identifying those input values for which the logarithm with base b evaluates to an integer number, or for which the distance to an integer number is below a certain threshold.

Following decision step 508 compares the calculated update value candidate k with the register value lower bound K_{low} and terminates the process with step 515 if k is smaller or equal to K_{low}, as in this case neither k, nor any subsequently created register value update candidate may change any register value.

If otherwise k is greater than K_{low}, the process continues with step 509, which randomly selects a register index for the register on which the update value candidate is applied. The random selection is performed without replacement, which means that for the processing of a given data record, each register index can be drawn at most one time. The Fisher-Yates algorithm may be used to implement this form of random selection in an efficient way.

Following decision step 510 compares the value of the register selected by step 509 with the register value update candidate k. In case k is not greater than the value currently stored in the selected register, the process continues with step 514, which increments the iteration counter j and then forwards to step 504 to start the next iteration.

If otherwise k is greater than the current value of the selected register, step 511 is executed, which stets the value of the selected register to the register value update candidate k. Step 511 may in addition increment the register update counter w by one.

Following decision step 512 compares the register update counter w with the number of registers of the processed SetSketch record m. If w is smaller than m, the process continues with step 514 to start the next iteration.

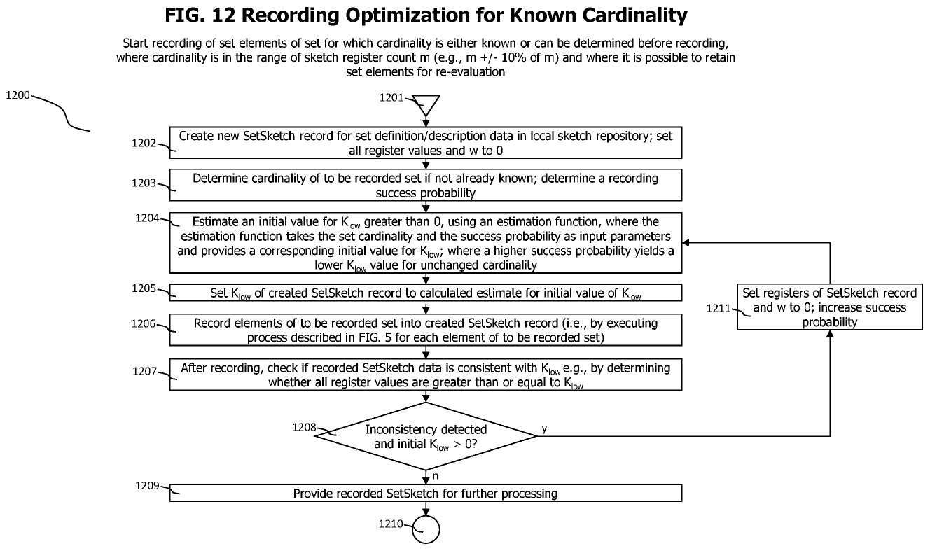

Otherwise, the values of the registers in the register store of the processed SetSketch record are scanned in step 513 to determine the lowest value of all registers. This lowest register value is set to K_{low}. As register values are only incremented, also the value of K_{low} can only be increased with every execution of step 513. As the initial value of K_{low} may be set to a value greater than 0 to increase the performance of the recording process in some situations (see e.g., FIG. 12), step 513 may also check if the lowest register value is greater than the current value of K_{low}, and only set K_{low} to the current lowest register value if it is greater than K_{low}. Step 513 also resets the register value count w to 0 to assure that the next update of K_{low} occurs after m updates of register values. After step 513, the process continues with step 514 to increment the iteration counter j and to start the next iteration.

Two variant approaches to create the ascending, exponentially distributed random numbers, as required for the execution of step 505 of process 500 are shown in FIG. 6.

A first variant which calculates the desired ascending random numbers by first drawing an exponentially distributed random number and then calculating the ascending random number by adding the drawn random number to the previously calculated random number is described in process 600. This leads to a recursive definition of the created random numbers, where the currently created random number xⱼ is calculated based on the previously calculated random number xⱼ₋₁.

The process starts with step 601 in which a new ascending random number is requested. The received request also contains the value of the previously created random number. If no previously calculated random number is available, the value 0 is used instead.

Following step 602 first executes the function Exp(a), which draws a random number form an exponential distribution with a rate set to the value of configuration parameter a.

The random number may then be divided by the result of register count m+1−iteration count j. To create the requested random number (xⱼ), the previously calculated random number (xⱼ₋₁) may be added to the result of the division. Step 603 afterwards provides the created random number the requester and the process then ends with step 604.

Another variant for creating ascending, exponentially distributed random values that uses ascending portions of an exponential distribution to draw the random numbers is described in process 610.

The process starts with step 611, when a request for the generation of a new random number is received. The request may also contain an index (j) of the to be created random number. The index may be used to select the portion of the exponential distribution from which the random number should be drawn.

Following step 612 calculates the domain of the exponential distribution from which the random number should be drawn. Step 612 may calculate a lower domain delimiter Yj−1 and an upper delimiter Yj using the formula specified in step 612. Yj−1 is calculated by applying this formula to j−1 and Yj by applying it to j. Following step 613 then draws a random number from a truncated exponential distribution with a rate set to configuration parameter a. The truncation of the exponential distribution is given by the domain starting and including the lower bound Yj−1 and ending with but not including the upper bound Yj. An efficient method to draw a random number from a truncated exponential distribution can be found in an article by Otmar Ertl entitled “ProbMinHash—A Class of Locality-Sensitive Hash Algorithms for the (Probability) Jaccard Similarity” IEEE Transactions on Knowledge and Data Engineering (November 2019) which is incorporated herein in its entirety by reference.

Following step 614 provides the created random number to the requester, e.g., to update a SetSketch record. The process then ends with step 615.

Although both variants create ascending, exponentially distributed random values that are drawn from an exponential distribution with rate parameter a, the quality of created random values differ, as the first variant described in process 600 provides independent random numbers but the second variant introduces a dependency between the created random values as each random value is drawn from another domain of the exponential distribution. Estimation results may differ depending on the used random values being statistically independent or not.

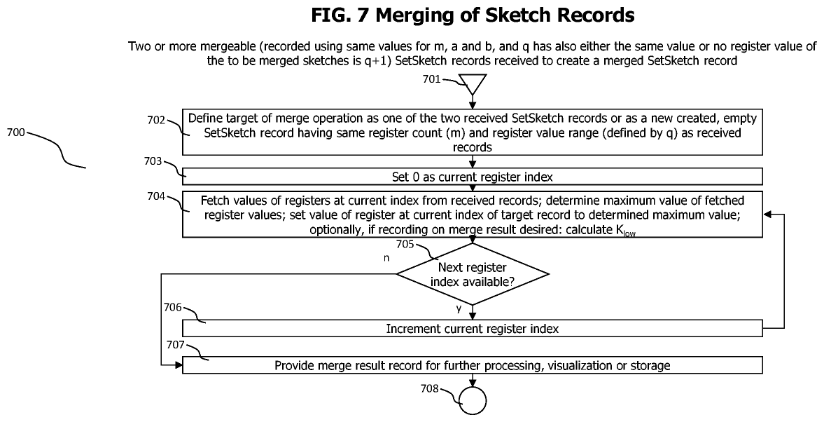

Coming now to FIG. 7, which provides the flowchart of a process that may be used to merge two or more SetSketch records representing portions of an observed set to create one SetSketch record representing the union set of those set portions.

The process 700 starts with step 701, when two or more mergeable SetSketch records are received. SetSketch records are mergeable recording those sketch records used the same values for parameters a and b and the sketches contain the same number of registers m. The register capacity of the received SetSketch records may differ, as long as no SetSketch record contains a register with a value indicating a register overflow (register value=q+1).

Following step 702 may then define the target of the merge operation. This may be one of the received SetSketch records, in this case the values of the other received records may be merged into the selected target record. Alternatively, a new, empty SetSketch record may be created that contains the same number of registers as the received SetSketch records with register having the same register capacity as the received SetSketch records.

For scenarios where the register capacity of the registers of received SetSketch varies, the register capacity of the target SetSketch record is chosen in a way that it can hold all register values that are contained in the received records.

Following step 703 may then set a current register index, which may be used to iterate over the registers of the received SetSketch records to 0.

Subsequent step 704 may then fetch the registers at the current register index from all received SetSketch records and select the fetched register with the highest register value 212. The highest register value may then be set as the value 212 of the register 210 of the target SetSketch record at register index 211 equal to the current register index. Step 704 may also calculate K_{low} for the merged SetSketch record if subsequent recording of set elements into the merged SetSketch record is desired.

Decision step 705 determines whether additional registers are available for processing. Step 705 may e.g., compare the current register index with the register count m. A current register index being smaller than m indicates the existence of further, not yet processed registers. If no further registers to process are available, the process continues with step 707, which provides the SetSketch record that was the result of this merging process for further processing, visualization, and storage. The process afterwards ends with step 708.

If otherwise step 705 determines that additional registers for processing are available, step 706 is executed which increments the current register index by 1. Step 704 is executed after step 706 to process the next set of registers.

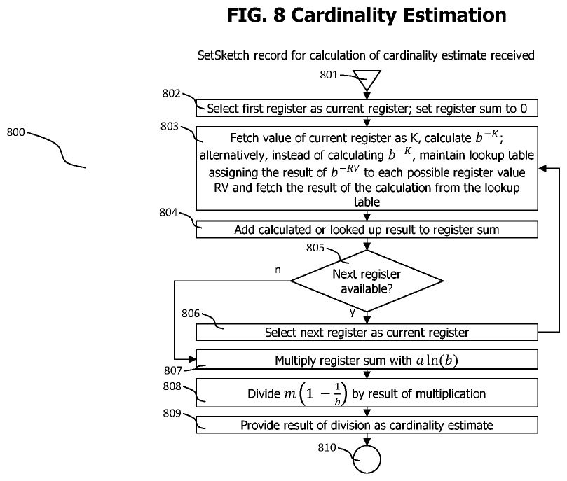

The analysis of a SetSketch record 115 by a cardinality estimator 124 to calculate an estimation for the cardinality described by the SetSketch record is described in FIG. 8.

The process 800 starts with step 801, when a SetSketch record for cardinality estimation is received. Following step 802 may select the first register 210 of the SetSketch record as current register and set a register sum value to 0.

Step 803 may then fetch the value 212 of the current register as K and calculate b to the power of −K as register summand. Alternatively, a lookup table may be created beforehand which maps each possible register value to the result of b to the power of the negative register value. Step 803 may then, instead of performing the above-described calculation, use this lookup table to fetch the corresponding calculation result/register summand for the current register value.

Following step 804 may then add the calculated of fetched register summand to the register sum.

Subsequent decision step 805 determines if the SetSketch record contains further register to process and continues with step 806 if further registers are available. Step 805 may determine if the number of already processed registers is smaller than the register count m and in case the number of already processed registers is smaller than m, continue with step 806 which selects the next register 210 from the register storage of the processed SetSketch records as current register and then continue with step 803 to process the new current register.

If otherwise all registers were already processed, decision step continues with step 807, which multiplies the register sum with the product of the configuration parameter a with the natural logarithm of the configuration parameter b. Following step 808 then multiplies the register count m with 1 minus the reciprocal value of configuration parameter b and divides the result of this multiplication by the result of the multiplication performed by step 807. Subsequent step 809 may then provide the result of the division performed by step 808 as result of the cardinality estimation.

The process then ends with step 810.

It should be noted that also other cardinality estimators may be applied on recorded SetSketch records to calculate cardinality estimates. An example for such an alternative cardinality estimator is described in the paper by S. Pettie and D. Wang entitled “Simpler and Better Cardinality Estimators for HyperLogLog and PCSA” ArXiv (August 2022) which is incorporated in its entirety herein by reference. Although this paper discusses the application of the proposed cardinality estimator on HyperLogLog and PCSA sketches, the introduced cardinality estimator may also be applied to SetSketch records with minor adaptations.

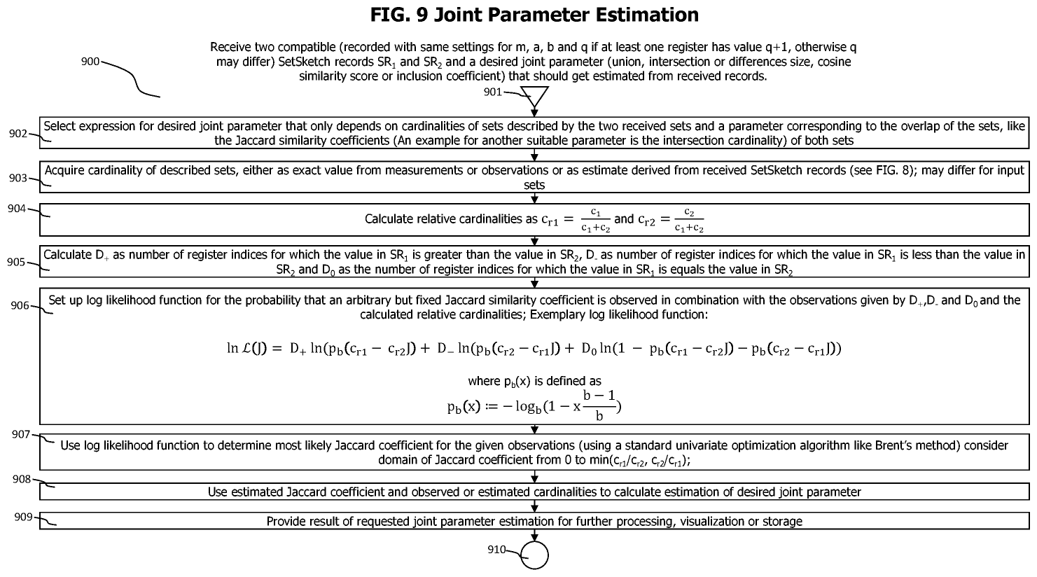

FIG. 9 provides the flow chart of a process 900 that may be used to determine joint parameters, like intersection cardinality or Jaccard index for set represented by two SetSketch records.

The process starts with step 901, when two compatible SetSketch records are received. Two SetSketch records are compatible when both have the same register count (m) and were recorded using the same values for configuration parameters a and b. Further, in case any of the register values 212 of the received SetSketch record is set to q+1, which indicates an overflow of the register, also the register capacity q of the received SetSketch records need to be identical.

Following step 902 may then select an expression for the joint parameter which should be estimated that only depends on the cardinalities of the sets described by the provided SetSketch records and the Jaccard index of those sets. Table 1 lists some exemplary joint parameters and their expression as function of relative cardinalities and Jaccard index. The relative cardinality of a set may be calculated by dividing the cardinality of the set by the sum of all set cardinalities. As an example, if sets a and b are given, the relative cardinality of set a may be calculated by dividing the cardinality of set a by the sum of the cardinalities of the sets a and b. Step 902 may be omitted if an estimation for the Jaccard index is requested.

TABLE 1
Mapping of joint parameters to expression depending on relative
cardinalities (Cᵤ and Cᵥ) and Jaccard index

| | | Expression in terms of |
|---|---|---|
| | | relative cardinalities |
| Joint parameter name | Set representation | and Jaccard index |
| Union cardinality | \|U ∪ V\| | $\frac{( {c}_{u} + {c}_{v} )}{1 + J}$ |
| Intersection cardinality | \|U ∩ V\| | $\frac{( {c}_{u} + {c}_{v} ) J}{1 + J}$ |
| Difference cardinalities | \|U \ V\|, \|V \ U\| | $\frac{{c}_{u} - {c}_{v} J}{1 + J} , \frac{{c}_{v} - {c}_{u} J}{1 + J}$ |
| Cosine similarity | $\frac{\vert U ⋂ V \vert}{\sqrt{\vert U \vert \vert V \vert}}$ | $\frac{( {c}_{u} + {c}_{v} ) J}{\sqrt{{c}_{u} {c}_{v}} ( 1 + J )}$ |
| Inclusion coefficients | $\frac{\vert U ⋂ V \vert}{\vert V \vert} , \frac{\vert U ⋂ V \vert}{\vert U \vert}$ | $\frac{( {c}_{u} + {c}_{v} ) J}{{c}_{u} ( 1 + J )} , \frac{( {c}_{u} + {c}_{v} ) J}{{c}_{v} ( 1 + J )}$ |

Following step 903 may then acquire the cardinalities of the sets described by the received SetSketch records. If those cardinalities are measured and reported independently of the SetSketch records and available as exact measures, step 903 may use those. Otherwise, the received SetSketch records may be used to calculate estimates for the cardinalities as described in FIG. 8. Step 903 and subsequent steps may then use the estimated cardinalities instead of exact ones.

Step 904 may then calculate relative cardinalities for both sets as quotient of the cardinality of one set divided by the sum of both cardinalities.

Afterwards, step 905 may analyze the registers 210 of both SetSketch records to calculate the summary statistics D₊, D₋ and D₀ which quantify the difference of the received records. D₊ is the number of register where the register value on a specific register index for the first SetSketch record is greater than the register value for the second SetSketch record at the same register index. D₋ counts the number of registers at a specific index where the second SetSketch record has a higher register value than the first SetSketch record at the same register index and D₀ counts the number of registers indices where the register of the first SetSketch record at a specific index has the same value as the register of the second SetSketch record at the specific index. Consequently, the sum of D₊, D₋ and D₀ equals the register count m. If two of the three statistics have been determined, the third one may be calculated by subtracting the two already known from m.

Step 906 then uses the previously determined values of D₊, D₋, D₀ and the calculated relative cardinalities to parameterize a log likelihood function, like the one described in step 906 and following step 907 may then iteratively determine a value for the Jaccard index that is most likely for the given observations described by the values of D₊, D₋, D₀ and the relative cardinalities. The proposed log likelihood function shows some properties that ease the process of finding an optimal/most probably value for the Jaccard index. First, as the cardinalities of the input set are already given, either as observations, or as estimations derived from the received SetSketch record, the problem is reduced from a multivariate optimization problem with the goal to e.g., find optimal values for the cardinalities and the Jaccard index, to the univariate optimization problem to find an optimal/most probable value for the Jaccard index. Second, the evaluation of the proposed log likelihood function is relatively cheap in terms of required calculations, as one evaluation requires the calculation of only five logarithms, as the evaluations of p_{b}(x) for the D₊ and the D₋ term can be reused for the D₀ term, which leads to the evaluation of three natural logarithms and two logarithms with basis b.

The domain of the Jaccard index is relatively small and reaches from 0 (disparate sets) to the minimum cardinality quotient (minimum of first cardinality divided by second and second cardinality divided by first), and the proposed log likelihood function has properties in this domain (e.g., strictly concave shape) that support a fast conversion of the optimization process. Standardized univariate optimization algorithms, like Brent's method may be used to find the optimal value for the Jaccard index.

Step 908 may then use the estimation value for the Jaccard index to evaluate the expression for the desired joint parameter that was selected in step 903. Step 908 may be omitted if an estimation of the Jaccard index was requested.

Step 909 then provides the estimation result for further processing, visualization, or storage. The process then ends with step 910.

It is noteworthy that the above-described joint parameter estimation approach may also be applied on other types of set sketching data structures that like Generalized HyperLogLog or Hyper MinHash sketch records. The only prerequisite is that the cardinality of the described sets significantly exceeds the number of registers of those other sketching data structures. As a rule of thumb, the proposed estimation approach may be applied on such other sketching data structures if the cardinality of the described sets exceeds the number of registers multiplied by the natural logarithm of the number of registers.

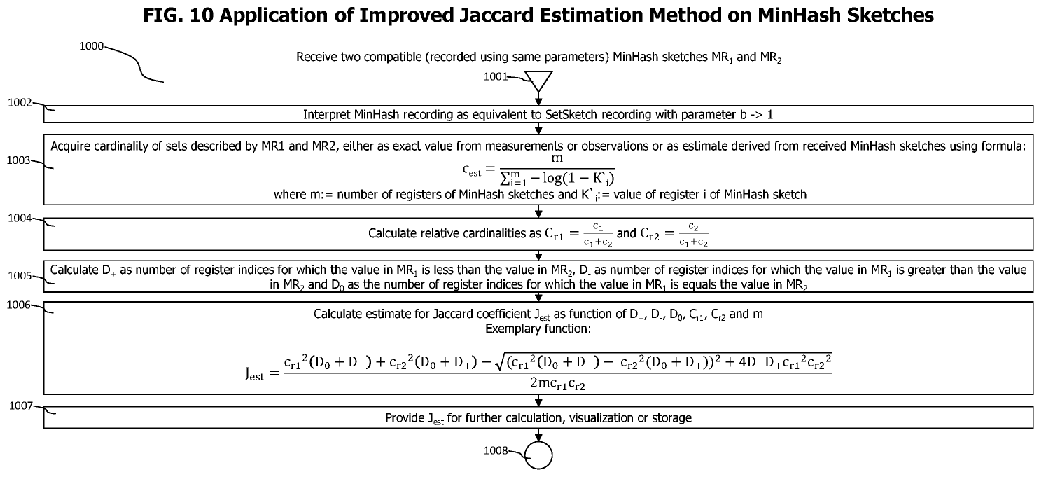

Coming now to FIG. 10, which provides an improved Jaccard index estimation for MinHash sketches that is inspired by the previously described evaluation of SetSketch records. Instead of the conventional estimation method for MinHash sketches, which only uses the number of registers having the same value, then new proposed estimation process also considers register values that are larger in the sketch record for first set than the corresponding register value of the sketch record for the second, and vice versa.

The process 1000 starts with step 1001, when two MinHash records having the same register count and register capacity are received. Following step 1002 interprets the received MinHash records as SetSketch recordings with parameter b converging to 1. Parameter b is used to control the amount of similarity information that is captured by the SetSketch record. The lower parameter b is, the more similarity information is captured. MinHash recording does not use such a control parameter and always captures full similarity information at the cost of a much higher memory footprint for the same desired estimation accuracy, compared to SetSketch.

Step 1003 afterwards determines the cardinality of the sets that are described by the received MinHash records, either from separately recorded cardinality monitoring data, or by using the MinHash records to calculate an estimation for the cardinality. As described in step 1003, the cardinality estimation may iterate over the register values K′ of the registers of each MinHash record, subtract the register value from 1, calculate the logarithm of the subtraction result and then add the negated results of the logarithm to calculate a register sum value. Alternatively, a lookup mechanism, which maps each possible register value to the corresponding result of above logarithm calculations may be used to avoid the repeated, expensive logarithm evaluations. The register count m of the received MinHash records may be determined and divided by the register sum value. The result of this division may then be used as cardinality estimation for the respective MinHash record and the set it describes.

Following step 1004 may then calculate relative cardinalities for both sets, as already described in step 904 of process 900.

Afterwards, step 1005 may calculate the D₊, D₋ and D₀ statistics from the MinHash records. Among other things, MinHash differs from SetSketch in the way register values are updated. MinHash updates a register when a candidate value is smaller than the currently stored register value and SetSketch updates if the candidate value is greater than the current register value. Therefore, also the calculation of D₊ and D₋ is different for the MinHash case, as D₊ is calculated as the number of registers where the value is smaller in the first MinHash record than the corresponding register value in the second MinHash record, and D₋ is calculated as the number of registers where the value of the second MinHash record is smaller than the corresponding register value of the first MinHash record. D₀ is calculated as the number of corresponding registers of both MinHash records (i.e., registers with the same register index) having the same value.

Step 1006 may then use the previously calculated values for D₊, D₋, D₀, the cardinality values and the register count m of the received MinHash records to calculate an estimation of the Jaccard index for the two sets represented by the received MinHash records. The function described step 1006 may be used for this calculation. It should be noted that this is a closed-form Jaccard index estimator that only requires one evaluation of the proposed formula. No iterative optimization process including multiple formular evaluations to determine a most probable Jaccard index value is required.

Following step 1007 then provides the calculated estimation of the Jaccard index for further processing, visualization, and storage. The process then ends with step 1008.

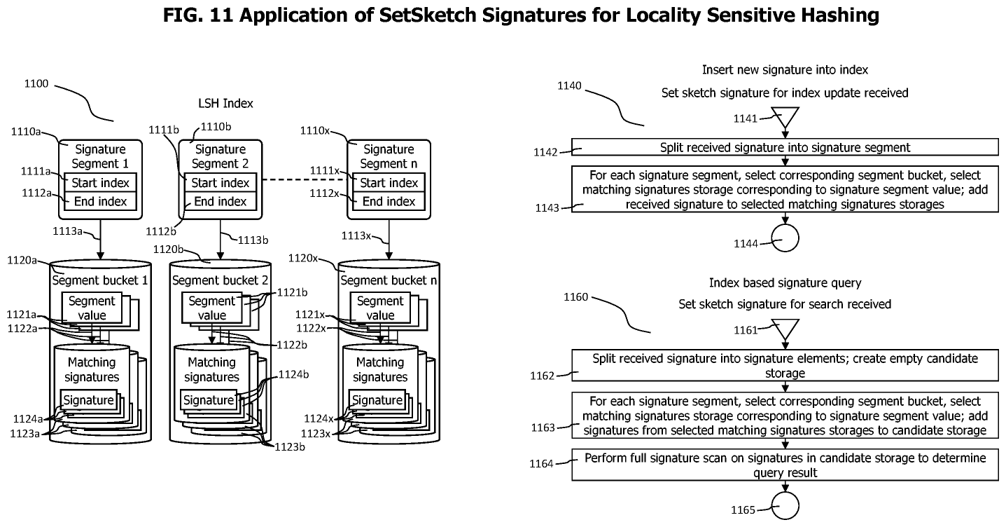

Coming now to FIG. 11 which outlines the usage of SetSketch records to create and use locality sensitive hashing (LSH) based indices. The collision probability behavior of SetSketch make it an interesting alternative for MinHash for the creation of LSH indices as has a much lower memory footprint than MinHash for similar supported cardinalities and desired estimation accuracies. For a detailed analysis of the collision probability behavior of SetSketch and why this qualifies SetSketch for usage in LSH indices, please see section 3.3 “Locality Sensitivity” of Appendix A.

A block diagram 1100 of an exemplary LSH index contains signature segments 1110a, 1110b to 1110x, where each signature segment represents a subset of the registers of SetSketch records defined by a start index 1111a, 1111b to 1111x and an end index 1112a, 1112b to 1112x.

Start index 1111 and end index 1112 define a range of register index values of register records 210 that are considered for a specific signature segment. As an example, only registers of a receive SetSketch record will be considered for a signature segment that have a register index 211 that is greater than the start index 1111 and smaller than the end index 1112. The register index ranges specified by the signature segments 1110a, 1110b to 1110x should cover the whole register index range (from 0 to m) of the processed SetSketch records. As a more concrete example, a LSH index designed to contain SetSketch records having 20 registers (m=20) may contain four signature segments. The start index of signature segment 1 may be set to 1 and end index to 5, for signature segment 2, start index may be 6 and end index 10, for segment 3 those values may be 11 and 15 and so on.

Each signature segment 1110a-1110x may refer 1113a-1113x a segment bucket 1120a-1120x.

A signature bucket 1120 may map 1122 specific segment values 1221 to a collection of matching signatures 1123, containing signatures 1124 (SetSketch record) that match the corresponding segment value 1121.

Segment values 1121 of a specific segment bucket 1120 referred by a specific signature segment 1110 contain the sequences of register values 212 from register records of received SetSketch records that fall into the register range defined by the start 1111 and end 1112 index of the signature segment. By a concrete example, a signature segment with start index set to 1 and end index set to 5, would for receiving SetSketch records a, b, c, d with register values a: 5, 7, 0, 9, 6, 8, 10, 16, 15, 8; b: 6, 4, 1, 9, 6, 5, 4, 12, 17, 0; c: 5, 7, 0, 9, 6, 1, 3, 6, 12, 7; and d: 6, 4, 1, 9, 6, 12, 9, 0, 7, 3 create a first segment value containing register values 5, 7, 0, 9, 6, 8, with a matching signatures collection containing the SetSketch records a and c (as their register values 1-5 match the first segment value) and create a second segment value containing register values 6, 4, 1, 9, 6 with an associated signature collection containing SetSketch records b and d.

Coming now to process 1140, which describes the insert of a new signature in form of a SetSketch record into an LSH index. The process starts with step 1141, when a new SetSketch record is received for index update. Subsequent step 1142 splits the register data of the received SetSketch record into register segments according to the start/end index 1111/1112 specified in the signature segments of the LSH index.

Following step 1143 then iterates over the created register segments. For each created register segment, step 1143 may fetch the corresponding signature segment 1110, e.g., by fetching for a given register segment with a given start and end index, the signature segment having the same start 1111 and end 1112 index. Step 1143 may then fetch the segment bucket 1120 corresponding 1113 to the fetched signature segment and calculate the segment value for the given register segment. Afterwards, step 1143 may use the calculated segment value to select the matching signatures container 1123 that is associated 1122 with the segment value 1121 that matches the calculated segment value. If no matching segment value is found in the fetched segment bucket 1120, a new one is created and associated with an empty matching signatures container 1123. The received SetSketch record is then added to the matching signature container associated the created or fetched segment value 1121 of the fetched segment bucket 1120. The process then ends with step 1144.

At the end of process 1140, each segment bucket 1120 of the LSH index contains a segment value 1121 that matches one of the register segments of the received SetSketch record. The matching signature containers 1123 associated 1122 to those segment values 1121 contain the received SetSketch record.

The usage of an LSH index to improve the performance of similarity queries is exemplary described in process 1160. The process is started with step 1161, when a query for already know SetSketch records that are similar to a query provided SetSketch record is received.

Following step 1162 may create register segments from the received SetSketch record according to start index 1111 and end index 1112 of the signature segments 1110 of the LSH index. In addition, step 1162 may create an empty candidate storage, for the storage of SetSketch records that match the LSH index query.

Following step 1163 then iterates over each segment signature 1110 of the LSH index. During this iteration, step 1163 may, for each signature segment 1110, use the previously created register segment that matches the start and end index of the signature segment to query the segment bucket 1120 associated 1113 with the signature segment for a segment value 1121 that matches the value of register segment. If a matching signature segment 1121 is found, the signatures/SetSketch records stored in the matching signatures container 1123 associated 1122 with the matching signature segment 112 are stored in the candidate storage.

Following step 1164 may then perform a full analysis of the signatures stored in the candidate storage to determine a query result. As an example, the similarity requirements of the received query may specify a minimum number registers that need to match to indicate similarity between two SetSketch records. In this case, step 1164 may iterate over the already pre-filtered list of signatures in the candidate storage to identify and select those signatures for which the number of matching registers equals or exceeds the minimum specified in the query. Step 1164 may then provide the query result for further processing, visualization, or storage. The process then ends with step 1165.

Coming now to FIG. 12, which describes how prior knowledge of the cardinality of a to be recorded set may be used to set the lower register value bound K_{low} to a value greater than 0 to improve the recording speed by enabling earlier exits of the recording process.

An initial value that is greater than 0 may be calculated for K_{low}, and the recording of the set may be performed using this initial value. After recording is finished, the status of the registers of the SetSketch record may be analyzed to determine whether it is consistent with the initial K_{low} value. As an example, one or more registers having a value lower than K_{low} after the recording is finished may be considered as an inconsistency. In this case, a new, lower initial value for K_{low} may be calculated and the recording may be repeated. Therefore, this approach is only applicable to situations where set elements can be kept and processed multiple times. The initial K_{low} value may be calculated based on the known set cardinality and a desired success probability parameter, where an increased success probability parameter indicating a higher success probability leads to a lower initial K_{low} value for unchanged cardinality. Presetting K_{low} with a value greater than 0 has the greatest benefit for medium set cardinalities. As a rule of thumb, those are cardinalities that are in the range of the register count of the SetSketch that is used to record the set. For small and large set sizes, the benefit is neglectable and is most times outweighed by the additional effort caused by potential reevaluations due by a too high initial K_{low}.

The process starts with step 1201, when a set is received for which the cardinality is already known, the cardinality is in a medium range (e.g., in a value range of m+/−10%, where m represents the number of registers of the SetSketch record used to record the set) and where the elements of the to be recorded set can be processed multiple times.

Following step 1202 may then create a SetSketch record in the local sketch repository and set all registers of the record and w to 0.

Following step 1203 may then determine or fetch the cardinality of the to be recorded set and also determine a success probability for the recording process. The success probability may be in the value range from 0 to 1 and defines a desired probability with which the to be performed recording of the received set that uses a specific initial value for K_{low} which is greater than 0 should not generate inconsistent SetSketch register values.

Step 1204 may then calculate an estimate for an initial value for K_{low}, using an estimation function which receives the cardinality of the set and the success probability and returns a corresponding initial value for K_{low}. An increase of the success probability, while keeping the cardinality unchanged, results in a decreased calculated initial value for K_{low}.

$$Equation 1 : Exact estimator for initial value of {K}_{low}$$

$${K}_{low}^{init} = ⌊ \frac{ln ( n a b ) - ln ( - ln ( 1 - {( 1 - ε )}^{\frac{1}{m}} ) )}{ln ( b )} ⌋$$

$$Equation 2 : Approximative estimator for initial value of {K}_{low}$$

$${K}_{low}^{init} \approx ⌊ \frac{ln ( n a b ) - ln ( - ln ( \frac{ε}{m} ) )}{ln ( b )} ⌋$$

Step 1204 may use either Equation 1 to calculate an exact initial value for K_{low} or Equation 2 to calculate an approximative initial value for K_{low}. In these equations, variables a and b represent the recording parameters of the SetSketch record for expected cardinality lower bound (variable a) and desired joint parameter estimation accuracy (variable b), variable m represents the number of registers of the SetSketch record, n is the cardinality of the to be recorded set, 1−ε represents the desired success probability and ln is the natural logarithm function.

Step 1205 may then set K_{low} of the created SetSketch record to the value calculated by step 1204 and subsequent step 1206 may then record the elements of the set to the SetSketch record, as described in FIG. 5.

After recording of the set is finished, step 1207 may determine whether the status of the registers of the SetSketch record are consistent with the value of K_{low}. Step 1207 may verify if all registers of the SetSketch record are greater than or equal to K_{low}. Having register values that are smaller than K_{low} after the recording is finished may be considered as an indicator that the initial value of K_{low} was chosen too high and some relevant register updates were missed due to this too high initial value.

Following decision step 1208 may then check whether the initial value for K_{low} that was used for the current recording of the set was greater than 0 and whether step 1207 identified an inconsistency. If an inconsistency was identified and the initial value of K_{low} was greater than 0, step 1208 continues the process with step 1211 in which the value for the success probability is increased and the register values of the SetSketch record and w are set to 0. After step 1211, the process continues with step 1204, which calculates a new, now lower initial value for K_{low}. A new recording of the set using the new initial value of K_{low} is then performed.

If either the initial value of K_{low} was already 0, or no inconsistencies were detected by step 1207, the process continues with step 1209 which provides the recorded SetSketch for further processing. The process then ends with step 1210.

Additional information can be found in an article by Otmar Ertl entitled “SetSketch: Filling the Gap between MinHash and HyperLogLog” VLDB 2021 which is incorporated in its entirety by reference herein.

The techniques described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

Some portions of the above description present the techniques described herein in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the described techniques include process steps and instructions described herein in the form of an algorithm. It should be noted that the described process steps and instructions could be embodied in software, firmware or hardware, and when embodied in software, could be downloaded to reside on and be operated from different platforms used by real time network operating systems.

The present disclosure also relates to an apparatus for performing the operations herein. This apparatus may be specially constructed for the required purposes, or it may comprise a computer selectively activated or reconfigured by a computer program stored on a computer readable medium that can be accessed by the computer. Such a computer program may be stored in a tangible computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various systems may also be used with programs in accordance with the teachings herein, or it may prove convenient to construct more specialized apparatuses to perform the required method steps. The required structure for a variety of these systems will be apparent to those of skill in the art, along with equivalent variations. In addition, the present disclosure is not described with reference to any particular programming language. It is appreciated that a variety of programming languages may be used to implement the teachings of the present disclosure as described herein.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for determining a performance metric in a distributed computing environment, comprising:
setting values of configuration parameters for a first sketching data structure, where the first sketching data structure is partitioned into a plurality of registers and the configuration parameters includes a recording parameter, b, that controls recording of data into the first sketching data structure;
receiving, by a monitoring server, a plurality of observation events resulting from transactions executed in the distributed computing environment, where each observation event includes data that associates the observation event with a given set and data that describes the observation event, wherein each observation event is generated by a sensor instrumented in an application executing at least a portion of the respective transaction;
determining, for each observation event in the plurality of observation events, a target set to which the observation event belongs using the data that associates the observation event with the target set;
extracting, for each observation event in the plurality of observation events, a value for a data element from the given observation event;
updating, for each observation event associated with the target set, the first sketching data structure based on the value of the data element from the given observation event and in accordance with the recording parameter; and
estimating cardinality of data in the target set using data stored in the first sketching data structure.

2. The method of claim 1 wherein the first sketching data structure is updated in accordance with the recording parameter b, such that changing value of the recording parameter changes maximum number of distinct data elements that can be represented by the first sketching data structure.

3. The method of claim 1 wherein the configuration parameters further include m as a number of registers in the first sketching data structure, and q as capacity of each resister in the first sketching data structure.

4. The method of claim 3 wherein updating the first sketching data structure further comprises
a) setting an iteration counter to one;
b) generating, with a random number generator, a random number using the value of the data element from the given transaction event, where the random number is selected from values having an exponential distribution and a is rate of the exponential distribution;
c) calculating an update candidate for the first sketching data, where calculating the updated candidate depends on recording parameter b;
d) randomly selecting a register from amongst the plurality of registers;
e) updating the selected register with the update candidate when the update candidate is larger than value of the selected register;
f) incrementing the iteration counter by one;
g) repeating steps b)-f) while the iteration counter is smaller than m.

5. The method of claim 4 further comprises
generating the random numbers in step b) in ascending order;
between step b) and step c) comparing the random number to a first update threshold, where the first update threshold is set to the recording parameter taken to power of minimum value stored in the plurality of registers and stop repeating steps b)-f) when the random number is larger than the first update threshold;
between step c) and step d) comparing the update candidate to the minimum value stored in the plurality of registers and stop repeating steps b)-f) when the update candidate is smaller or equal to the minimum value stored in the plurality of registers.

6. The method of claim 5 wherein the random numbers are generated in ascending order by drawing a new random number from an exponential distribution with rate set to value of a and adding the new random number to a previously generated random number, where the new random number is divided m+1−j before being summed with the previously generated random number and j is value of the current iteration count.

7. The method of claim 5 wherein the random numbers are generated by segmenting an exponential distribution with rate set to value of a into a plurality of adjacent, non-overlapping segments and drawing the random number from a given segment in the plurality of adjacent, non-overlapping segments, where the given segment corresponds to the current iteration and the number of adjacent, non-overlapping segments equals the number of registers in the first sketching data structure.

8. The method of claim 3 further comprises calculating the update candidate by evaluating logarithm of base b for the random number, truncating the logarithm result to an integer and bounding the integer within the range of possible register values.

9. The method of claim 3 further comprises estimating cardinality of the represented data elements by
calculating b^{-K} for each register in the plurality of registers and sum results thereof, where b is the recording parameter and K is value of a corresponding register;
multiplying the sum with a and natural logarithm of b to yield a first product;
multiplying m by difference of one minus reciprocal value of the recording parameter to yield a second product; and
dividing the second product by the first product.

10. The method of claim 1 further comprises
receiving, by the monitoring server, a second sketching data structure, where the second sketching data structure is compatible with the first sketching data structure; and
estimating a set similarity of the data elements represented by the first sketching data structure and data elements represented by the second sketching data structure using data stored in the first and second sketching data structures.

11. The method of claim 10 wherein the first sketching data structure and second sketching data structure have configuration parameters with same values.

12. The method of claim 10 wherein estimating similarity further comprises determining d0 as a number of corresponding registers in the first and second sketching data structures having the same value;
determining d+ as a number of registers in the first sketching data structure having a higher value than corresponding register in the second sketching data structure;
determining d− as a number of registers in the first sketching data structure having a lower value than corresponding register in the second sketching data structure;
estimating cardinality of data in a second target set using data stored in the second sketching data structure;
defining a log likelihood function using the d0, d+, d−, the cardinality of the target set and the cardinality of the second target set and the recording parameter b, where the log likelihood function yields an estimate for Jaccard index for the data in the target set and the second target set.

13. The method of claim 10 wherein the first sketching data structure is updated in accordance with the recording parameter b, such that changing the recording parameter to increase maximum number of distinct data elements that can be represented by the first sketching data structure decreases the amount of similarity information encoded therein and vice versa.

14. A computer-implemented method for determining a performance metric in a distributed computing environment, comprising:
setting values of a configuration parameters for a first sketching data structure, where the first sketching data structure is partitioned into a plurality of registers and the configuration parameters includes m as a number of registers in the first sketching data structure, q as capacity of each resister in the first sketching data structure; a as rate of an exponential distribution and a recording parameter, b, that controls recording of data into the first sketching data structure;
receiving, by a data recorder, a plurality of observation events resulting from activities executed in the distributed computing environment, where each observation event includes data that associates the observation event with a given set and data that that describes properties of an element of the given set, wherein each observation event is generated by a sensor instrumented in an application executing at least a portion of the activities;
determining, for each observation event in the plurality of observation events, a target set to which the observation event belongs using the data that associates the observation event with the given set;
determining, for each observation event in the plurality of observation events, an update value for the first sketching data structure, where the update value is derived from a logarithm of a specific base for a pseudo-random number, where the specific base is value of the recording parameter b and the pseudo-random number is selected from the exponential distribution with a rate set to a;
selectively updating, for each observation event in the plurality of observation events, the first sketching data structure based on the update value; and
estimating cardinality of data in the target set using data stored in the first sketching data structure.

15. The method of claim 14 wherein the sketching data structure is updated in accordance with the recording parameter, such that changing value of the recording parameter changes maximum number of distinct set elements that can be represented by the first sketching data structure.

16. The method of 14 where register values are only updated with an update value when the update value is greater than the value currently stored in the register;
where a first update value derived from a first random value is greater than a second update value derived from a second random value when the first random value is smaller than the second random value;
creating the sequence of pseudo-random values in ascending order;
determining the smallest register value stored in the registers of the first sketching data structure;
monitoring the number of register value updates that occurred since determination of the smallest register value;
determining the smallest register value again, in response to the number of register value updates since the last determination of the smallest register value exceeds a certain threshold, where a new determined smallest register value is greater than any previously determined smallest register value and a current update value is smaller than any previously determined update value;
comparing the current update value with the monitored smallest register count;
stop processing of the observation event to create further update values in response to the smallest register value being larger than the current update value.

17. The method of claim 14 wherein the pseudo-random number is generated by drawing a new random number from the exponential distribution and adding the new random number to a previously generated random number, where the new random number is divided m+1−j before being summed with the previously generated random number and j is value of the current iteration.

18. The method of claim 14 wherein the pseudo-random random number is generated by segmenting the exponential distribution into a plurality of adjacent, non-overlapping segments and drawing the random number from a given segment in the plurality of adjacent, non-overlapping segments, where the given segment corresponds to the current iteration and the number of adjacent, non-overlapping segments equals the number of registers in the sketching data structure.

19. The method of claim 14 wherein the update value is determined by evaluating logarithm of base b for the pseudo-random number, truncating the logarithm result to an integer and bounding the integer within the range of possible register values.

20. The method of claim 14 further comprises estimating cardinality of the data elements by
calculating b^{-K} for each register in the plurality of registers and sum results thereof, where b is the recording parameter and K is value of a corresponding register;
multiplying the sum with a and natural logarithm of b to yield a first product;
multiplying m by difference of one minus reciprocal value of the recording parameter to yield a second product; and
dividing the second product by the first product.

21. The method of claim 14 further comprises
receiving a second sketching data structure, where the second sketching data structure is compatible with the first sketching data structure; and
estimating similarity of the data elements represented by the first sketching data structure and the second sketching data structure using data stored in the first and second sketching data structures.

22. The method of claim 21 wherein the first sketching data structure and second sketching data structure are compatible if they have configuration parameters with same values.

23. The method of claim 21 wherein estimating similarity further comprises
determining d0 as a number of corresponding registers in the first and second sketching data structures having the same value;
determining d+ as a number of registers in the first sketching data structure having a higher value than corresponding register in the second sketching data structure;
determining d− as a number of registers in the first sketching data structure having a lower value than corresponding register in the second sketching data structure;
estimating cardinality of data in a second target set using data stored in the second sketching data structure;
defining a log likelihood function using the d0, d+, d−, the cardinality of the target set and the cardinality of the second target set and the recording parameter b, where the log likelihood function yields an estimate for Jaccard index for the data in the target set and the second target set.

24. The method of claim 21 wherein the first sketching data structure is updated in accordance with the recording parameter b, such that changing the recording parameter to increase maximum number of distinct data elements that can be represented by the first sketching data structure decreases the amount of similarity information encoded therein and vice versa.
